(19) United States
(12) Patent Application Publication
(10) Pub. No.: US 2024/0056223 A1
(43) Pub. Date: Feb. 15, 2024

(54) METHODS, DEVICES, AND COMPUTER READABLE MEDIUM FOR COMMUNICATION

(71) Applicant: NEC CORPORATION, Tokyo (JP)

(72) Inventors: Lin LIANG, Beijing (CN); Gang WANG, Beijing (US)

(73) Assignee: NEC CORPORATION, Tokyo (JP)

(21) Appl. No.: 18/270,147

(22) PCT Filed: Jan. 13, 2021
(86) PCT No.: PCT/CN2021/071592

§ 371 Date: Jun. 28, 2023

(51) Int. Cl. H04L 1/08; H04W 72/0446; H04W 72/232; H04W 72/1268

(52) U.S. Cl. CPC H04L 1/08; H04W 72/0446; H04W 72/232; H04W 72/1268

(57) ABSTRACT

Embodiments of the present disclosure relate to methods, devices and computer readable media for PUSCH repetition. According to embodiments of the present disclosure, the terminal device determines a set of physical uplink shared channel, PUSCH, repetition occasion slots based on a first omission rule. Then, the terminal device determines, from the set of PUSCH repetition occasion slots, PUSCH repetition actual slots based on a second omission rule. And then, the terminal device transmits data in the determined PUSCH repetition actual slots. In this way, an enhanced PUSCH enhancement solution is provided, thereby improving coverage of the network and increasing robustness of the uplink transmission.

### TECHNICAL FIELD

Embodiments of the present disclosure generally relate to the field of telecommunication, and in particular, to methods, devices and computer storage media for physical uplink shared channel (PUSCH) repetitions.

### BACKGROUND

Enhancements on the support for multi-transmission and reception point (multi-TRP) deployment have been discussed in 3GPP meeting. For example, it has been proposed to identify and specify features to improve reliability and robustness for physical channels (such as, a physical downlink control channel (PDCCH), a physical uplink shared channel (PUSCH) and/or a physical uplink control channel (PUCCH)) other than a physical downlink shared channel (PDSCH) using multi-TRP and/or multi-panel with Release 16 reliability features as a baseline.

To enhance coverage for a new radio network, repetition is one of the most effective ways to enhance the uplink coverage since transmission power can be accumulated in time domain by user equipment (UE). Repetitions on PUSCH need to be further studied.

### SUMMARY

In general, embodiments of the present disclosure provide methods, devices and computer storage media for PUSCH repetitions.

In a first aspect, there is provided a method of communication. The method comprises: determining, at a terminal device, a set of physical uplink shared channel, PUSCH, repetition occasion slots based on a first omission rule; determining, from the set of PUSCH repetition occasion slots, PUSCH repetition actual slots based on a second omission rule; and transmitting data in the determined PUSCH repetition actual slots.

In a second aspect, there is provided a method of communication. The method comprises: determining, at a terminal device, a set of physical uplink shared channel, PUSCH, repetition occasion slots based on a counting rule for counting PUSCH repetition occasion slots; determining, from the set of PUSCH repetition occasion slots, PUSCH repetition actual slots based on an omission rule; and transmitting data in the determined PUSCH repetition actual slots.

In a third aspect, there is provided a terminal device. The terminal device comprises a processor and a memory coupled to the processor. The memory stores instructions that when executed by the processor, cause the terminal device to perform the method according to the first aspect or the second aspect of the present disclosure.

In a fourth aspect, there is provided a computer readable medium having instructions stored thereon. The instructions, when executed on at least one processor, cause the at least one processor to perform the method according to the first aspect or the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow of a process for PUSCH repetition in accordance with some embodiments of the present disclosure;

FIG. 3 illustrates a signaling flow of a process for PUSCH repetition in accordance with some embodiments of the present disclosure;

FIG. 4 illustrates an example method of communication implemented at a terminal device in accordance with some embodiments of the present disclosure;

FIG. 5 illustrates an example method of communication implemented at a network device in accordance with some embodiments of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but is not limited to, user equipments (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like.

The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, a first information may be transmitted to the terminal device from the first network device and a second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (memories) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, to enhance coverage for a new radio network, repetition is one of the most effective ways to enhance the uplink coverage since transmission power can be accumulated in time domain by UE. There are two types of PUSCH repetition in current (rel-16) NR which are type A and type B. Type A is slot based PUSCH repetition. That is, the retransmission is in a unit of slot. Type B is mini-slot based retransmission or symbol based retransmission.

Mechanism for enhancement on PUSCH repetition type A is needed to be studied. In one aspect, it is being considered to maximize the maximum number of repetitions for PUSCH up to a number. In another aspect, it is also considered to increase the number of repetitions counted on the basis of available slots for uplink transmission.

For PUSCH repetition Type A, when transmitting PUSCH scheduled by DCI format 0_1 or 0_2 in PDCCH with CRC scrambled with C-RNTI, MCS-C-RNTI, or CS-RNTI with NDI=1, the number of repetition K may be determined as below:
if the numberOfRepetitions-r16 is present in a resource allocation table, the number of repetitions K is equal to numberOfRepetitions-r16;
if the UE is configured with pusch-AggregationFactor, the number of repetitions K is equal to pusch-AggregationFactor. Otherwise, K is equal to 1.

For PUSCH repetition Type A, in case K>1, the same symbol allocation is applied across the K consecutive slots and the PUSCH is limited to a single transmission layer. The UE shall repeat the transmission block (TB) across the K consecutive slots applying the same symbol allocation in each slot. The redundancy version to be applied on the nth transmission occasion of the TB, where n=0, 1, . . . K−1, is determined according to table 6.1.2.1-2 as below.

TABLE 1
Redundancy Version

| | rv_{id} to be applied to n^{th} transmission occasion | | | |
|---|---|---|---|---|
| rv_{id} indicated | (repetition Type A) or n^{th} actual repetition ) | | | |
| by the DCI | (repetition Type B | | | |
| scheduling the | n mod | n mod | n mod | n mod |
| PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

For PUSCH repetition Type A, a PUSCH transmission in a slot of a multi-slot PUSCH transmission is able to be omitted according to the conditions in Clause 9, Clause 11.1 and Clause 11.2A of [6, TS38.213].

For example, in a time division duplexing (TDD) system, if a current slot is for uplink transmission, and if K is configured as 8, then there will be 8 consecutive slots for transmitting the PUSCH repetitions. However, it may happen that, among the 8 consecutive slots, one or more slots might be configured by the system for downlink transmission. In this case, the slot cannot be used for uplink transmission. Then, the slot is omitted.

Further, there are normally fewer slots for uplink transmission then for downlink transmission, considering more downlink traffic existed in a network. In such case, though a predetermined number of consecutive slots are configured (e.g., K=8 consecutive slots), only 2 slots is able to be used for uplink transmission finally, and the rest 6 slots are for downlink transmission. As such, the uplink transmission can only be transmitted twice. Accordingly, the coverage of the network might not be good enough since actually uplink retransmission happen only twice.

Meanwhile, the inventors of the present disclosure notice that there might be some solution as below. One straightforward solution is to configure the number K to be a higher value, for example, configuring K to be 16. As a result, there might be more (e.g., 4) uplink transmission repetition, conditioning that there are 2 out of 8 slots is able to be used for uplink transmission when K is configured as 8. That is, the higher the number K, the actually times of retransmission would increase accordingly.

Moreover, the inventors of the present disclosure also notice that K=4 might be configured directly, however, 4 means 4 available slots for uplink transmission which is not necessarily to be consecutive slots. In this case, 4 slots can be secured for uplink repetition transmission.

Meanwhile, the inventors of the present disclosure notice there are at least the following problems concerning PUSCH repetitions.

First, there are many omission rules in current NR specification. Definition of available slot for PUSCH repetition is not clear. Which rules apply to available slot and which rules does not apply to available slot should be specified.

Further, network and UE should have consistent understanding on actual repetition number and transmission slot. Only static configuration (e.g., sent from network device via RRC) can be used by UE to determine the availability of a slot, because UE may miss dynamic indication. However, some omitting rule is based on dynamic indication. Specifically, in some examples, there are some omitting rules which are based on dynamic indications. In such situation, the network device and the terminal device might have different understanding on actual repetition number and transmission slot. For example, when there are dynamic indications for omission, it might be that a network device transmits a DCI format 2_4 for a serving cell for cancelling a PUSCH transmission. However, due to some reasons (e.g., the poor quality of network), a terminal device fails to receiving the DCI format 2_4. In such case, the network device would understand it as there is at least one slot being omitted, whereas the terminal device which didn't receive the DCI format 2_4 won't perform omission. As a result, the network device and the terminal device would have different understanding of the actual number thus ending of PUSCH repetition.

Furthermore, it is not clear whether applying a second omission rule on an available slot, and the inventors of the present disclosure thinks the second omission rule should be applied after a first omission rule that determines the available slots. As such, the omission rules may be applied in a binding way, that is, there is no step-wise way for applying different kind of omission rules.

In order to solve at least part of the above mentioned problems, solutions on PUSCH repetition is provided. According to embodiments of the present disclosure, the terminal device transmits data in the determined PUSCH repetition occasion slots. In this way, the terminal device determines a set of PUSCH repetition occasion slots based on a first omission rule. Then, the terminal device further determines, from the set of PUSCH repetition occasion slots, PUSCH repetition actual slots based on a second omission rule. Accordingly, the terminal device transmits data in the determined PUSCH repetition actual slots. As such, definition of available slot (i.e. the repetition number K) for PUSCH repetition is clear based on a first omission rule. In addition, the second omission rule applied after a first omission rule can determines the available slots. As a result, an enhanced PUSCH enhancement solution is provided, thereby improving coverage of the network and increasing robustness of the uplink transmission.

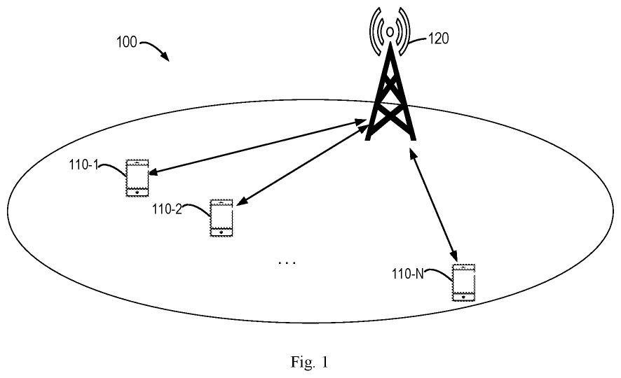

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N may be any suitable integer number.

The communication system 100 further comprises a terminal device 110-1, a network device 120-2, . . . , a network device 120-M, which can be collectively referred to as “network device(s) 120.” In some embodiments, the network device may be gNB. Alternatively, the network device may be IAB. The number M may be any suitable integer number. In the communication system 100, the network devices 120 and the terminal devices 110 may communicate data and control information to each other. Only for the purpose of illustrations, the network device 120-1 may be regarded as a source network device and the network device 120-2 may be regarded as a target network device. The numbers of terminal devices 110 and network devices 120 shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: code divided multiple address (CDMA), frequency divided multiple address (FDMA), time divided multiple address (TDMA), frequency divided duplexer (FDD), time divided duplexer (TDD), multiple-input multiple-output (MIMO), orthogonal frequency divided multiple access (OFDMA) and/or any other technologies currently known or to be developed in the future.

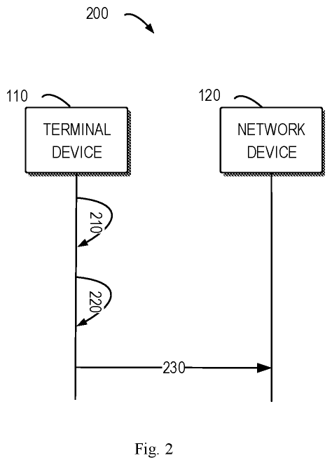

Example embodiments of the present disclosure will be described in detail below with reference to the accompanying drawings. Reference is now made to FIG. 2, which illustrates a signaling flow 200 for PUSCH repetitions in accordance with example embodiments of the present disclosure. For the purpose of discussion, the signaling flow 200 will be described with reference to FIG. 1. Only for the purpose of illustrations, the signaling flow 200 may involve a terminal device 110 and a network device 120.

In the following, the terms “transmission occasion”, “transmission” and “repetition” can be used interchangeably. The terms “DCI”, “DCI format” and “PDCCH” can be used interchangeably.

As shown in FIG. 2, a terminal device 110 determines 210 a set of physical uplink shared channel, PUSCH, repetition occasion slots based on a first omission rule. In some embodiments, the first omission rule may be received, from a network device 120, in a RRC message. In such embodiments, the first omission rule may be: for a set of symbols of a slot that are indicated to the terminal device 110 as downlink, the terminal device 110 does not transmit PUSCH when the PUSCH, overlaps, even partially, with the set of symbols of the slot. In some other embodiments, the first omission rule may also be: for a set of symbols of a slot indicated to the terminal device 110 by ssb-PositionsInBurst, for reception of SS/PBCH blocks, the terminal device 110 does not transmit PUSCH, in the slot if a transmission would overlap with any symbol from the set of symbols of the slot.

In some embodiments, since there are many conditions for omission. The conditions may be divided into two types. One type may be called static type, which includes, those configured via RRC message. For example, Clause 11.1 of TS38.213 includes many such kind of rule. Another type may be called dynamic type, which may include, omission rules configured via DCI. Omission rules may also be configured via MAC-CE. For example, Clause 9 and Clause 11.2A as defined in TS 38.213 includes such kind of rules. Some more concrete examples of static rules and dynamic rules will be provided in details later.

Now returning back to FIG. 2, after determining the set of PUSCH repetition occasion slots, the terminal device 110 determines 220, from the set of PUSCH repetition occasion slots, PUSCH repetition actual slots based on the second omission rule. Accordingly, the terminal device 110 transmits 230 data in the determined PUSCH repetition actual slots.

As such, the terminal device 110 may apply omission rule with two step for an enhanced type (e.g., Type A-1 may be considered as an enhanced type for Type A) configuration. Then, based on, for example, Type A-1 configuration of K repetition, the terminal device 110 may apply the first omission rule to determine the K PUSCH occasion slots. And then the terminal device 110 may apply the second omission rule to determine whether to cancel the PUSCH transmission on the nth PUSCH occasion slot. Accordingly, definition of available slot for PUSCH repetition is clear based on a first omission rule. Furthermore, a second omission rule is applied after a first omission rule that determines the available slots. In this way, an enhanced PUSCH enhancement solution is provided, thereby improving coverage of the network and increasing robustness of the uplink transmission.

It would be appreciated that, although this above method is illustrated as for slot-based retransmission, it may also apply to mini-slot based and symbol based retransmission. That is, both type A and type B of PUSCH repetition in current NR or other types which might be defined in the future for PUSCH repetition may use the above method. The protection scope of the present disclosure is not limited in this regards.

In some embodiments, the terminal device 110 may receive, from the network device 120, DCI or a MAC-CE indicating the second omission rule. In such embodiment, the second omission rule may include overlapping for PUCCH and/or PUSCH transmissions of different priority indexes. For example, as defined in Clause 9 of TS 38.213, when a terminal device 110 determines overlapping for PUCCH and/or PUSCH transmissions of different priority indexes, the terminal device 110 first resolves the overlapping for PUCCH and/or PUSCH transmissions of smaller priority index as described in Clause 9.2.5 of TS 38.213. Then, if a transmission of a first PUCCH of larger priority index scheduled by a DCI format in a PDCCH reception would overlap in time with a transmission of a second PUSCH or a second PUCCH of smaller priority index, the terminal device 110 cancels the transmission of the second PUSCH or the second PUCCH before the first symbol that would overlap with the first PUCCH transmission. If a transmission of a first PUSCH of larger priority index scheduled by a DCI format in a PDCCH reception would overlap in time with a transmission of a second PUCCH of smaller priority index, the terminal device 110 cancels the transmission of the second PUCCH before the first symbol that would overlap with the first PUSCH transmission.

Alternatively, the second omission rule may be when the terminal device 110 detects a DCI format 2_4 for a serving cell cancels a PUSCH transmission. In such example, as defined in Clause 11.2A of TS38.213, a terminal device 110 that detects a DCI format 2_4 for a serving cell cancels a PUSCH transmission or an actual repetition of a PUSCH transmission if the PUSCH transmission is with repetition Type B, as determined in Clauses 9 and 9.2.5 or in Clause 6.1 of TS 38.214, or an SRS transmission on the serving cell if, respectively,
the transmission is PUSCH with priority 0, if the terminal device 110 is provided applicabilityforCI,
a group of symbols, from the T_{CI} symbols, has at least one bit value of ‘1’ in the corresponding set of N_{BI} bits in the DCI format 2_4 and includes a symbol of the (repetition of the) PUSCH transmission or of the SRS transmission, and
a group of PRBs, from the B_{CI} PRBs, has a corresponding bit value of ‘1’ in the set of bits corresponding to the group of symbols in the DCI format 2_4 and includes a PRB of the (repetition of the) PUSCH transmission or of the SRS transmission,
   where
the cancellation of the (repetition of the) PUSCH transmission includes all symbols from the earliest symbol of the (repetition of the) PUSCH transmission that is in a group of symbols having corresponding bit values of ‘1’ in the DCI format 2_4;

In some embodiment, the terminal device 110 may receive, from the network device 120, a message which includes the second predetermined number. In such embodiments, the second predetermined number may indicate a limit (e.g., an upper limit) for a plurality of PUSCH repetition occasion slots, where the set of PUSCH repetition occasion slots is determined from the plurality of PUSCH repetition occasion slots. As such, the terminal device 110 may determine the set of PUSCH repetition occasion slots based on the first omission rule, the first predetermined number and the second predetermined number.

For example, for PUSCH repetition Type A-1, the second predetermined number may be M which is configured together with repetition number K. And K′ is the number of PUSCH repetition occasions within M consecutive slots. The terminal device 110 may repeat the TB across the MIN(K, K′) PUSCH repetition occasion slots applying the same symbol allocation in each slot. As a result, over-repetition can be avoided.

In some embodiments, the terminal device 110 may receive, from the network device 120, a message for configuring the terminal device 110 to be in a PUSCH repetition mode (e.g., the enhanced type A-1), where the PUSCH repetition mode is used for transmitting a PUSCH transmission scheduled by a predetermined downlink control information in a physical downlink control channel transmission. For example, the predetermined downlink control information may be DCI format 0_1 or 0_2 in PDCCH.

In some embodiments, the PUSCH repetition mode may be used for transmitting the PUSCH transmission scheduled by the predetermined downlink control information in a physical downlink control channel transmission with a cyclic redundancy check, CRC, scrambled with a cell-radio network temporary identifier, C-RNTI, a modulation and coding scheme-cell-radio network temporary identifier, MCS-C-RNTI, or a configured scheduling-radio network temporary identifier, CS-RNTI, with a new data indicator, NDI. Different PUSCH repetition mode may be configured for different predetermined downlink control information in a physical downlink control channel transmission.

In some embodiments, a MAC-CE may indicate the terminal device 110 to switch between different types. For example, the MAC-CE may indicate the terminal device 110 to switch between type A and type A-1 or between type B and type B-1 (an enhance type for type B). In some other embodiments, a new bit field or combined encoding/interpretation of existing bit field in DCI indicates uplink grant using type A or type A-1 dynamically.

In some embodiments, the number of actual repetition transmission by uplink control information (UCI)/MAC CE may be reported via PUSCH to the network device 120. As such the network device 120 is able to know the actual repetition transmission.

In some example embodiments, the network device 120 may indicate the terminal device 110 the number of actual PUSCH transmission and/or indication that continue or stop repetition by DCI/MAC CE. In some embodiments, indication may include the rest number of repetition. The terminal device 110 may adjust the repetition scheme based on the remaining number of repetition when terminal device 110 receives the indication. It should be appreciated that the actual repetition number of terminal device 110 could be larger than RRC configured number though dynamic DCI indication.

In some embodiments, for PUSCH repetition Type A-1, in case K>1, the same symbol allocation is applied across the K PUSCH repetition occasion consecutive slots and the PUSCH is limited to a single transmission layer. A slot is PUSCH repetition occasion slot when PUSCH transmission in a slot is not omitted according to the conditions in Clause 11.1 of [6, TS38.213]. The terminal device 110 shall repeat the TB across the K PUSCH repetition occasion consecutive slots applying the same symbol allocation in each slot. The redundancy version to be applied on the nth transmission occasion of the TB, where n=0, 1, . . . K−1, is determined according to table 6.1.2.1-2. For PUSCH repetition Type A and Type A-1, a PUSCH transmission in a slot of a multi-slot PUSCH transmission is omitted according to the conditions in Clause 9, Clause 11.1 and Clause 11.2A of [6, TS38.213].

Since Clause 9 and Cause 11.2A has been provided as examples of dynamic type in the above section. In the following part, a few examples of static rules will be provided with reference to Clause 11.1 of TS38.213.

For example, according to TDD frame structure, the slots for downlink transmission may be determined in advance in a more static way. That is, according to the TDD frame structure, the terminal device 110 may be configured to use some frame as downlink one and some frame to be used for uplink transmission. As a result, the terminal device 110 is able to know in advance which frames are configured by the system to perform uplink transmission.

In some embodiments, according to Clause 11.1, a terminal device 110 considers symbols in a slot indicated as downlink by tdd-UL-DL-ConfigurationCommon, or tdd-UL-DL-ConfigurationDedicated to be available for receptions and considers symbols in a slot indicated as uplink by tdd-UL-DL-ConfigurationCommon, or by tdd-UL-DL-ConfigurationDedicated to be available for transmissions.

For a set of symbols of a slot that are indicated to a terminal device 110 as downlink by tdd-UL-DL-ConfigurationCommon, or tdd-UL-DL-ConfgurationDedicated, the terminal device 110 does not transmit PUSCH, PUCCH, PRACH, or SRS when the PUSCH, PUCCH, PRACH, or SRS overlaps, even partially, with the set of symbols of the slot.

For operation on a single carrier in unpaired spectrum, for a set of symbols of a slot indicated to a terminal device 110 by ssb-PositionsInBurst in SIB1 or ssb-PositionsInBurst in ServingCellConfigCommon, for reception of SS/PBCH blocks, the terminal device 110 does not transmit PUSCH, PUCCH, PRACH in the slot if a transmission would overlap with any symbol from the set of symbols and the terminal device 110 does not transmit SRS in the set of symbols of the slot.

In some embodiments, if a terminal device 110 is not configured to monitor PDCCH for DCI format 2_0, for a set of symbols of a slot that are indicated as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the terminal device 110:
the terminal device 110 receives PDSCH or CSI-RS in the set of symbols of the slot if the terminal device 110 receives a corresponding indication by a DCI format;
the terminal device 110 transmits PUSCH, PUCCH, PRACH, or SRS in the set of symbols of the slot if the terminal device 110 receives a corresponding indication by a DCI format, a RAR UL grant, fallbackRAR UL grant, or successRAR.

In some embodiments, for operation on a single carrier in unpaired spectrum, if a terminal device 110 is configured by higher layers to transmit SRS, or PUCCH, or PUSCH, or PRACH in a set of symbols of a slot and the terminal device 110 detects a DCI format indicating to the terminal device 110 to receive CSI-RS or PDSCH in a subset of symbols from the set of symbols, then the terminal device 110 cancels the PUCCH, or the PUSCH, or an actual repetition of the PUSCH [6, TS 38.214], determined from Clauses 9 and 9.2.5 or Clause 6.1 of [6. TS 38.214], or the PRACH transmission in remaining symbols from the set of symbols and cancels the SRS transmission in remaining symbols from the subset of symbols.

In some embodiments, for a set of symbols of a slot indicated to a terminal device 110 as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the terminal device 110, and if the terminal device 110 detects a DCI format 2_0 providing a format for the slot using a slot format value other than 255:
if an SFI-index field value in DCI format 2_0 indicates the set of symbols of the slot as flexible and the terminal device 110 detects a DCI format, a RAR UL grant, fallbackRAR UL grant, or successRAR indicating to the terminal device 110 to transmit PUSCH, PUCCH, PRACH, or SRS in the set of symbols of the slot the terminal device 110 transmits the PUSCH, PUCCH, PRACH, or SRS in the set of symbols of the slot;
if an SFI-index field value in DCI format 2_0 indicates the set of symbols of the slot as flexible, and the terminal device 110 does not detect a DCI format indicating to the terminal device 110 to receive PDSCH or CSI-RS, or the terminal device 110 does not detect a DCI format, a RAR UL, fallbackRAR UL grant, or successRAR grant indicating to the terminal device 110 to transmit PUSCH, PUCCH, PRACH, or SRS in the set of symbols of the slot, the terminal device 110 does not transmit or receive in the set of symbols of the slot;
if the terminal device 110 is configured by higher layers to transmit PUCCH, or PUSCH, or PRACH in the set of symbols of the slot, the terminal device 110 transmits the PUCCH, or the PUSCH, or the PRACH in the slot only if an SFI-index field value in DCI format 2_0 indicates the set of symbols of the slot as uplink.

In some embodiments, if a terminal device 110 is configured by higher layers to transmit SRS, or PUCCH, or PUSCH, or PRACH in a set of symbols of a slot and the terminal device 110 detects a DCI format 2_0 with a slot format value other than 255 that indicates a slot format with a subset of symbols from the set of symbols as downlink or flexible, or the terminal device 110 detects a DCI format indicating to the terminal device 110 to receive CSI-RS or PDSCH in a subset of symbols from the set of symbols, then
the terminal device 110 cancels the PUCCH, or the PUSCH, or an actual repetition of the PUSCH [6, TS 38.214], determined from Clauses 9 and 9.2.5 or Clause 6.1 of [6. TS 38.214], or the PRACH transmission in remaining symbols from the set of symbols and cancels the SRS transmission in remaining symbols from the subset of symbols.

For a set of symbols of a slot that are indicated as flexible by tdd-UL-DL-ConfigurationCommon, and tdd-UL-DL-ConfigurationDedicated if provided, or when tdd-UL-DL-ConfigurationCommon, and tdd-UL-DL-ConfigurationDedicated are not provided to the terminal device 110, and if the terminal device 110 does not detect a DCI format 2_0 providing a slot format for the slot:
if the terminal device 110 is configured by higher layers to transmit SRS, or PUCCH, or PUSCH, or PRACH in the set of symbols of the slot and the terminal device 110 is not provided EnableConfiguredUL-r16, the terminal device 110;
does not transmit the PUCCH, or the PUSCH, or the PRACH in the slot and does not transmit the SRS in symbols from the set of symbols in the slot.

The inventors of the present application also noticed that, due to the existence of a variety of omission rule (e.g., dynamic one such as DCI format 2_4), the actual transmission of PUSCH repetitions might be different from the available slots for uplink transmission. That is, the available number of repetitions cannot be reached during real transmissions.

In one example, when a network device 120 (e.g., a base station) may configure a terminal device 110 to perform PUSCH repetition to be 8, then 2 slots are cancelled due to a DCI format 2_4 detected for canceling a PUSCH transmission or an actual repetition of a PUSCH transmission. Then, the actual number of reception transmission is 6, thus the coverage is not as good as 8 repetitive PUSCH transmissions.

In order to solve at least part of the above mentioned problems, solutions on PUSCH repetition is provided. According to embodiments of the present disclosure, a terminal device 110 determines a set of physical uplink shared channel, PUSCH, repetition occasion slots based on a counting rule for counting PUSCH repetition occasion slots. Then, the terminal device 110 determines, from the set of PUSCH repetition occasion slots, PUSCH repetition actual slots based on an omission rule. Accordingly, the terminal device 110 transmits data in the determined PUSCH repetition actual slots. In this way, the actual number of repetition transmission is able to be fixed and secured, for example, to be a predetermined number, thereby improving the coverage for uplink transmission of the network.

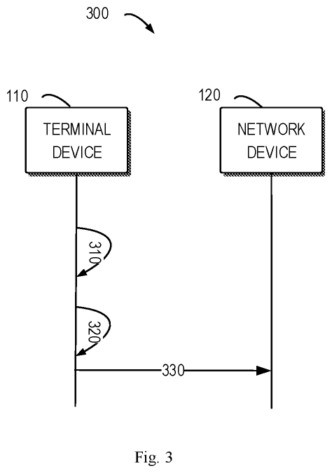

FIG. 3 shows a signaling flow 300 illustrating the process for PUSCH repetition in accordance with some embodiments of the present disclosure. For the purpose of discussion, the signaling flow 300 will be described with reference to FIG. 1. The signaling flow 300 may involve a terminal device 110, a network device 120 as illustrated in FIG. 1.

In the signaling flow 300, a terminal device 110 determines 310 a set of physical uplink shared channel, PUSCH, repetition occasion slots based on a counting rule for counting PUSCH repetition occasion slots.

In some embodiments, for example, the terminal device 110 may determines M consecutive slots based on configured repetition number K. M is the smallest integer that there are K counted PUSCH within M consecutive slots according to the counting rule. Then the terminal device 110 applies omission rule across M consecutive slots.

In such embodiments, if it is determined that a PUSCH transmission in one slot of the plurality of consecutive slots is not omitted based on an omission rule for omitting a PUSCH transmission, the terminal device 110 may count the slot as one of the set of PUSCH repetition occasion slots.

For example, if a PUSCH in a slot is omitted according to only RRC (static) configuration of Uplink, Downlink and Flexible, it is uncounted. Otherwise, it is counted. It means that a PUSCH omission due to DCI (dynamic) indication is also counted in this way. In this way, the number of consecutive slots M is fixed and the actual transmission is variable.

Alternatively, if a PUSCH in a slot is omitted according to either RRC (static) configuration of Uplink, Downlink and Flexible or DCI (dynamic) indication, it is uncounted. Otherwise, it is counted. As such, the number of consecutive slots M is variable and the actual transmission is fixed. Further, in such embodiments, if it is determined that a PUSCH transmission in one slot of the plurality of consecutive slots is omitted due to failing to detect downlink control information providing slot format information, the terminal device 110 may count the slot as one of the number of counted PUSCH repetition occasion slots. The set of symbols of the slot are flexible for transmission. As such, if the terminal device 110 fails to be detect DCI indication that the network device 120 has transmitted, the fail of receiving the DCI indication (e.g., including slot format indication (SFI) index field) or the fail of decoding DCI which indicates the terminal device 110 to use the set of symbols of the slot as uplink will be counted as one PUSCH repetition transmission, even though no PUSCH repetition transmission is actually performed due to lack to receiving the DCI indication. As such, no more extra resource will be allocated for this failure due to the failure at the terminal device 110 side.

In some embodiments, if it is determined that a PUSCH transmission in one slot of the plurality of consecutive slots is omitted and a part of symbols in the PUSCH transmission of the slot have been transmitted, the slot may be counted as one of the set of PUSCH repetition occasion slots. Alternatively, if it is determined that a PUSCH transmission in one slot of the plurality of consecutive slots is omitted and the number of the transmitted symbols of the slot exceeds a threshold value, the slot may be counted as one of the set of PUSCH repetition occasion slots.

Then, the terminal device 110 determines 320, from the set of PUSCH repetition occasion slots, PUSCH repetition actual slots based on an omission rule. Accordingly, the terminal device 110 transmits 330 data in the determined PUSCH repetition actual slots.

In some embodiments, for PUSCH repetition Type A-2, in case K>1, the same symbol allocation is applied across the M consecutive slots and the PUSCH is limited to a single transmission layer, a PUSCH transmission in a slot of a multi-slot PUSCH transmission is omitted according to the conditions in Clause 9, Clause 11.1 and Clause 11.2A of [6, TS38.213]. M is the smallest integer that there are K counted PUSCH within M consecutive slots according to the counting rule.

In some embodiments, the terminal device 110 shall repeat the TB across the M PUSCH repetition occasion consecutive slots applying the same symbol allocation in each slot. The redundancy version to be applied on the nth transmission occasion of the TB, where n=0, 1, . . . M−1, is determined according to table 6.1.2.1-2.

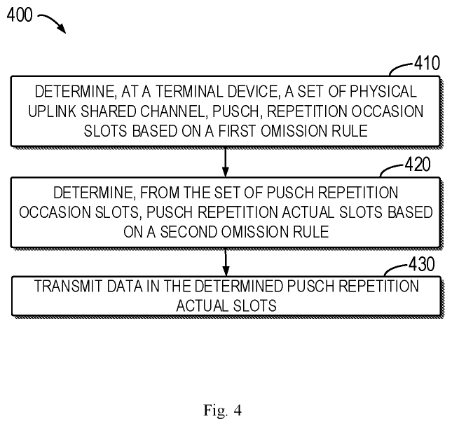

FIG. 4 shows a flowchart of an example method 400 in accordance with an embodiment of the present disclosure. Only for the purpose of illustrations, the method 400 can be implemented at a terminal device 110 as shown in FIG. 1.

At block 410, the terminal device 110 determines a set of physical uplink shared channel, PUSCH, repetition occasion slots based on a first omission rule. At block 420, the terminal device 110 determines, from the set of PUSCH repetition occasion slots, PUSCH repetition actual slots based on a second omission rule. At block 430, the terminal device 110 transmits data in the determined PUSCH repetition actual slots.

In some embodiment, receiving, from the network device, a radio resource control message comprising the first omission rule.

In some embodiment, the method further comprises receives, from the network device, downlink control information or a medium access control-control element, MAC-CE, indicating the second omission rule.

In some embodiment, the method further comprises receives, from the network device, a message comprising a second predetermined number indicating a limit for a plurality of PUSCH repetition occasion slots, the set of PUSCH repetition occasion slots being determined from the plurality of PUSCH repetition occasion slots. And determining the set of PUSCH repetition occasion slots comprises: determining the set of PUSCH repetition occasion slots based on the first omission rule, the first predetermined number and the second predetermined number.

In some embodiment, the method further comprises receives, from the network device, a message for configuring the terminal device to be in a PUSCH repetition mode, the PUSCH repetition mode being used for transmitting a PUSCH transmission scheduled by a predetermined downlink control information in a physical downlink control channel transmission.

In some embodiment, the PUSCH repetition mode is used for transmitting the PUSCH transmission scheduled by the predetermined downlink control information in a physical downlink control channel transmission with a cyclic redundancy check, CRC, scrambled with at least one of: a cell-radio network temporary identifier, C-RNTI, a modulation and coding scheme-cell-radio network temporary identifier, MCS-C-RNTI, and a configured scheduling-radio network temporary identifier, CS-RNTI, with a new data indicator, NDI.

In some embodiment, the message comprises the first predetermined number.

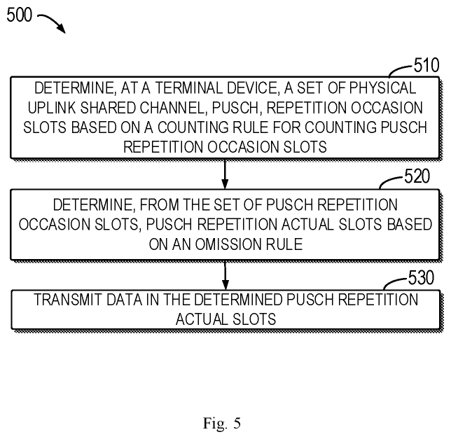

FIG. 5 shows a flowchart of an example method 500 in accordance with an embodiment of the present disclosure. Only for the purpose of illustrations, the method 500 can be implemented at a terminal device 110 as shown in FIG. 1.

At block 510, the terminal device 110 determines a set of physical uplink shared channel, PUSCH, repetition occasion slots based on a counting rule for counting PUSCH repetition occasion slots.

In some embodiment, determining the set of PUSCH repetition occasion slots comprises: in accordance with a determination that a PUSCH transmission in one slot of the plurality of consecutive slots is not omitted based on a further omission rule for omitting a PUSCH transmission, counting the slot as one of the set of PUSCH repetition occasion slots.

In some embodiment, determining the set of PUSCH repetition occasion slots comprises: in accordance with a determination that a PUSCH transmission in one slot of the plurality of consecutive slots is omitted due to failing to detect downlink control information providing slot format information, counting the slot as one of the number of counted PUSCH repetition occasion slots, wherein a set of symbols of the slot are flexible for transmission.

In some embodiment, determining the set of PUSCH repetition occasion slots comprises: in accordance with a determination that a PUSCH transmission in one slot of the plurality of consecutive slots is omitted and a part of symbols in the PUSCH transmission of the slot have been transmitted, counting the slot as one of the set of PUSCH repetition occasion slots.

In some embodiment, determining the set of PUSCH repetition occasion slots comprises: in accordance with a determination that a PUSCH transmission in one slot of the plurality of consecutive slots is omitted and a number of the transmitted symbols of the slot exceeds a threshold value, counting the slot as one of the set of PUSCH repetition occasion slots.

At block 520, the terminal device 110 determines, from the set of PUSCH repetition occasion slots, PUSCH repetition actual slots based on an omission rule. At block 530, the terminal device 110 transmits data in the determined PUSCH repetition actual slots.

In some embodiment, the method further comprises receiving, from the network device, a message for configuring the terminal device to be in a PUSCH repetition mode, the PUSCH repetition mode being used for transmitting a PUSCH transmission scheduled by predetermined downlink control information in a physical downlink control channel transmission.

In some embodiment, the PUSCH repetition mode is used for transmitting the PUSCH transmission scheduled by the predetermined downlink control information in a physical downlink control channel transmission with a cyclic redundancy check, CRC, scrambled with at least one of: a cell-radio network temporary identifier, C-RNTI, a modulation and coding scheme-cell-radio network temporary identifier, MCS-C-RNTI, or a configured scheduling-radio network temporary identifier, CS-RNTI, with a new data indicator, NDI.

In some embodiments, a terminal device (for example, the terminal device 110) comprising circuitry configured to: determine a set of physical uplink shared channel, PUSCH, repetition occasion slots based on a first omission rule; determine, from the set of PUSCH repetition occasion slots, PUSCH repetition actual slots based on a second omission rule; and transmit data in the determined PUSCH repetition actual slots.

In some embodiments, the circuitry is further configured to receive, from the network device, a radio resource control message comprising the first omission rule.

In some embodiments, the circuitry is further configured to receive, from the network device, downlink control information or a medium access control-control element, MAC-CE, indicating the second omission rule.

In some embodiments, the circuitry is further configured to receive, from the network device, a message comprising a second predetermined number indicating a limit for a plurality of PUSCH repetition occasion slots, the set of PUSCH repetition occasion slots being determined from the plurality of PUSCH repetition occasion slots; and determining the set of PUSCH repetition occasion slots comprises: determining the set of PUSCH repetition occasion slots based on the first omission rule, the first predetermined number and the second predetermined number.

In some embodiments, the circuitry is further configured to receive, from the network device, a message for configuring the terminal device to be in a PUSCH repetition mode, the PUSCH repetition mode being used for transmitting a PUSCH transmission scheduled by a predetermined downlink control information in a physical downlink control channel transmission.

In some embodiments, the PUSCH repetition mode is used for transmitting the PUSCH transmission scheduled by the predetermined downlink control information in a physical downlink control channel transmission with a cyclic redundancy check, CRC, scrambled with at least one of: a cell-radio network temporary identifier, C-RNTI, a modulation and coding scheme-cell-radio network temporary identifier, MCS-C-RNTI, and a configured scheduling-radio network temporary identifier, CS-RNTI, with a new data indicator, NDI.

In some embodiments, the message comprises the first predetermined number.

In some embodiments, a terminal device (for example, the terminal device 110) comprising circuitry configured to: determine, at a terminal device, a set of physical uplink shared channel, PUSCH, repetition occasion slots based on a counting rule for counting PUSCH repetition occasion slots; determine, from the set of PUSCH repetition occasion slots, PUSCH repetition actual slots based on an omission rule; and transmit data in the determined PUSCH repetition actual slots.

In some embodiments, determining the set of PUSCH repetition occasion slots comprises: in accordance with a determination that a PUSCH transmission in one slot of the plurality of consecutive slots is not omitted based on a further omission rule for omitting a PUSCH transmission, counting the slot as one of the set of PUSCH repetition occasion slots.

In some embodiments, determining the set of PUSCH repetition occasion slots comprises: in accordance with a determination that a PUSCH transmission in one slot of the plurality of consecutive slots is omitted due to failing to detect downlink control information providing slot format information, counting the slot as one of the number of counted PUSCH repetition occasion slots, wherein a set of symbols of the slot are flexible for transmission.

In some embodiments, determining the set of PUSCH repetition occasion slots comprises: in accordance with a determination that a PUSCH transmission in one slot of the plurality of consecutive slots is omitted and a part of symbols in the PUSCH transmission of the slot have been transmitted, counting the slot as one of the set of PUSCH repetition occasion slots.

In some embodiments, determining the set of PUSCH repetition occasion slots comprises: in accordance with a determination that a PUSCH transmission in one slot of the plurality of consecutive slots is omitted and a number of the transmitted symbols of the slot exceeds a threshold value, counting the slot as one of the set of PUSCH repetition occasion slots.

In some embodiments, the circuitry is further configured to receive, from the network device, a message for configuring the terminal device to be in a PUSCH repetition mode, the PUSCH repetition mode being used for transmitting a PUSCH transmission scheduled by a predetermined downlink control information in a physical downlink control channel transmission.

In some embodiments, the PUSCH repetition mode is used for transmitting the PUSCH transmission scheduled by the predetermined downlink control information in a physical downlink control channel transmission with a cyclic redundancy check, CRC, scrambled with at least one of: a cell-radio network temporary identifier, C-RNTI, a modulation and coding scheme-cell-radio network temporary identifier, MCS-C-RNTI, or a configured scheduling-radio network temporary identifier, CS-RNTI, with a new data indicator, NDI.

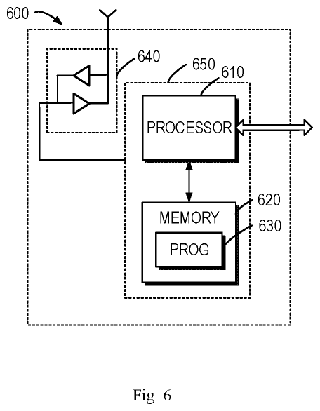

FIG. 6 is a simplified block diagram of a device 600 that is suitable for implementing embodiments of the present disclosure. The device 600 can be considered as a further example implementation of the network device 120 or the terminal device 110 as shown in FIG. 1. Accordingly, the device 600 can be implemented at or as at least a part of the network device 120 or the terminal device 110.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 610 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a mobility management entity (MME)/serving gateway (S-GW) and the eNB, Un interface for communication between the eNB and a relay node (RN), or Uu interface for communication between the eNB and a terminal device.

The program 630 is assumed to include program instructions that, when executed by the associated processor 610, enable the device 600 to operate in accordance with the embodiments of the present disclosure, as discussed herein with reference to FIGS. 1 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 850 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-16. (canceled)

17. A method of communication performed at a terminal device, the method comprising:
receiving from a base station, at least one of tdd-UL-DL-ConfigurationCommon, tdd-UL-DL-ConfigurationDedicated, or ssb-PositionsInBurst;
determining a set of slots for a physical uplink shared channel, PUSCH, transmission,
wherein the set of slots comprises a first slot and a second slot,
wherein the set of slots is based on a number of slots and a number of repetitions,
wherein the first slot is not counted in the set of slots if at least one of symbols allocated for the PUSCH transmission in the first slot overlaps with a downlink symbol indicated by tdd-UL-DL-ConfigurationCommon or tdd-UL-DL-ConfigurationDedicated, or a symbol of an SS/PBCH block provided by ssb-PositionsInBurst; and
performing omission in the second slot according to a condition.

18. The method of claim 17, wherein the at least one of tdd-UL-DL-ConfigurationCommon, tdd-UL-DL-ConfigurationDedicated, or ssb-PositionsInBurst is received in a radio resource control message.

19. The method of claim 17, further comprising:
receiving, from the network device, information configuring the number of repetitions.

20. The method of claim 19, wherein the number of repetitions is for the PUSCH transmission scheduled by Downlink Control Information, DCI format 0_1 or 0_2.

21. A method of communication performed at a base station, the method comprising:
transmitting to a terminal device, at least one of tdd-UL-DL-ConfigurationCommon, tdd-UL-DL-ConfigurationDedicated, or ssb-PositionsInBurst, wherein:
a set of slots for a physical uplink shared channel, PUSCH, transmission, is determined by the terminal device;
the set of slots comprises a first slot and a second slot;
the set of slots is based on a number of slots and a number of repetitions; and
the first slot is not counted in the set of slots if at least one of symbols allocated for the PUSCH transmission in the first slot overlaps with a downlink symbol indicated by tdd-UL-DL-ConfigurationCommon or tdd-UL-DL-ConfigurationDedicated, or a symbol of an SS/PBCH block provided by ssb-PositionsInBurst; and
receiving the PUSCH transmission from the terminal device, wherein omission in the second slot is performed according to a condition.

22. The method of claim 21, wherein the at least one of tdd-UL-DL-ConfigurationCommon, tdd-UL-DL-ConfigurationDedicated, or ssb-PositionsInBurst is transmitted in a radio resource control message.

23. The method of claim 21, further comprising:
receiving, from the network device, information configuring the number of repetitions.

24. The method of claim 23, wherein the number of repetitions is for the PUSCH transmission scheduled by Downlink Control Information, DCI format 0_1 or 0_2.

25. A terminal device, comprising:
one or more computer readable memory storing program instructions; and
one or more processors configured to execute the program instructions to perform operations comprising:
receiving from a base station, at least one of tdd-UL-DL-ConfigurationCommon, tdd-UL-DL-ConfigurationDedicated, or ssb-PositionsInBurst;
determining a set of slots for a physical uplink shared channel, PUSCH, transmission,
wherein the set of slots comprises a first slot and a second slot,
wherein the set of slots is based on a number of slots and a number of repetitions,
wherein the first slot is not counted in the set of slots if at least one of symbols allocated for the PUSCH transmission in the first slot overlaps with a downlink symbol indicated by tdd-UL-DL-ConfigurationCommon or tdd-UL-DL-ConfigurationDedicated, or a symbol of an SS/PBCH block provided by ssb-PositionsInBurst; and
performing omission in the second slot according to a condition.

26. The terminal device of claim 25, wherein the at least one of tdd-UL-DL-ConfigurationCommon, tdd-UL-DL-ConfigurationDedicated, or ssb-PositionsInBurst is received in a radio resource control message.

27. The terminal device of claim 25, the operations further comprising:
receiving, from the network device, information configuring the number of repetitions.

28. The terminal device of claim 27, wherein the number of repetitions is for the PUSCH transmission scheduled by Downlink Control Information, DCI format 0_1 or 0_2.
